(19) United States
(12) Patent Application Publication
(10) Pub. No.: US 2012/0203506 A1
(43) Pub. Date: Aug. 9, 2012

(54) INFORMATION PROCESSING APPARATUS, CONTROL METHOD THEREFOR, AND NON-TRANSITORY COMPUTER READABLE STORAGE MEDIUM

(75) Inventors: Koji Hatanaka, Yokohama-shi (JP); Masahiro Satoh, Sagamihara-shi (JP)

(73) Assignee: CANON KABUSHIKI KAISHA, Tokyo (JP)

(21) Appl. No.: 13/360,864

(22) Filed: Jan. 30, 2012

(30) Foreign Application Priority Data
Feb. 4, 2011 (JP) 2011-023243

(51) Int. Cl. G06F 15/00

(52) U.S. Cl. 702/176

(57) ABSTRACT

An information processing apparatus comprising, an acquisition unit acquiring information of a shooting time-and-date from each of a plurality of image data and information of a positioning time-and-date from each of a plurality of GPS log files, and a processing unit specifying a GPS log file corresponding to each image data by comparing the shooting time-and-date information with the positioning time-and-date information. If the shooting time-and-date information contains first time-and-date information according to UTC, the processing unit specifies the corresponding GPS log file by comparing the first time-and-date information with the positioning time-and-date information. If the shooting time-and-date information contains the time-and-date information in a local time, the processing unit converts the shooting time-and-date information into second time-and-date information according to UTC based on time difference information, and specifies the corresponding GPS log file by comparing the second time-and-date information with the positioning time-and-date information.

### BACKGROUND OF THE INVENTION

1. Field of the Invention

The present invention relates to an information processing apparatus, a control method therefor, and a non-transitory computer readable storage medium.

2. Description of the Related Art

An apparatus which receives a signal from a GPS (Global Positioning System) satellite and uses received position information and time-and-date information has become widespread. For example, there is a digital camera which incorporates a GPS reception function and can record shot image data added with positioning information. There is also a GPS log apparatus for periodically storing received position information and time-and-date information, and generating a moving route and the like as log information. The image data and log information generated by these apparatuses have position information such as a latitude and longitude. Displaying the position information on a map can help recall events associated with a shooting location or moving route.

Furthermore, even when a digital camera has no GPS reception function, it is possible to carry a GPS log apparatus to match log information recorded by the GPS log apparatus with time-and-date information added to image data by the digital camera (see Japanese Patent Laid-Open No. 2001-091290). Application software for a computer or an apparatus, which has a function of adding, later, position information to image data is also available.

### SUMMARY OF THE INVENTION

To associate image data with log information, a shooting time-and-date added to the image data and time-and-date information contained in the log information may be referred to. In many cases, the image data is generally based on the Exif standard and the shooting time-and-date is described by a local time. To the contrary, since information received by the GPS contains UTC (Universal Time, Coordinated), the log information may record a time-and-date according to UTC, which has been acquired from a satellite. By only referring to the time-and-date contained in the image data and that contained in the log information, therefore, it is impossible to determine the relationship between them.

According to the present invention, even if both a local time and UTC exist, it is possible to determine the relationship between image data and log information.

One embodiment of the present invention relates to an information processing apparatus comprising, an acquisition unit configured to acquire, from each of a plurality of image data, information of a time-and-date when the image data is shot, and to acquire information of a positioning time-and-date from each of a plurality of GPS log files, and a processing unit configured to specify a GPS log file corresponding to each image data by comparing the information of a time-and-date when the image data is shot acquired from each of the plurality of image data with the positioning time-and-date information acquired from each of the plurality of GPS log files, wherein in case that the information of the time-and-date when the image data is shot contains first time-and-date information according to UTC (Universal Time, Coordinated), the processing unit specifies the corresponding GPS log file by comparing the first time-and-date information with the positioning time-and-date information, and in case that the information of the time-and-date when the image data is shot contains not the first time-and-date information but information of a shooting time-and-date described by a local time, the processing unit converts the shooting time-and-date information into second time-and-date information according to UTC based on time difference information, and specifies the corresponding GPS log file by comparing the second time-and-date information with the positioning time-and-date information.

Further features of the present invention will become apparent from the following description of exemplary embodiments (with reference to the attached drawings).

### BRIEF DESCRIPTION OF THE DRAWINGS

The accompanying drawings, which are incorporated in and constitute a part of the specification, illustrate embodiments of the invention, and together with the description, serve to explain the principles of the invention.

FIG. 1 is a functional block diagram showing a system according to an embodiment of the present invention;

FIG. 2 is a view showing a display screen example of application software according to the embodiment of the present invention;

FIG. 3 is a view showing an example of the data structure of image data according to the embodiment of the present invention;

FIG. 4 is a view showing an example of the data structure of a GPS log file according to the embodiment of the present invention;

FIG. 5 is a flowchart illustrating an operation example of the application software according to the embodiment of the present invention;

FIG. 6 is a table showing a structure example of a log management list 600 according to the embodiment of the present invention;

FIG. 7 is a table showing a structure example of an image management list 700 according to the embodiment of the present invention;

FIG. 8 is a flowchart illustrating an example of processing of creating the image management list 700 according to the embodiment of the present invention; and

FIGS. 9A and 9B are flowcharts illustrating an example of processing of searching for a corresponding file according to the embodiment of the present invention.

### DESCRIPTION OF THE EMBODIMENTS

An embodiment of the present invention will be described in detail below with reference to the accompanying drawings. A so-called computer will be exemplified as an information processing apparatus according to the embodiment of the present invention.

In the embodiment, a digital camera with a GPS reception function is assumed as an image capturing apparatus according to the embodiment of the present invention. Assume that the digital camera records shot image data added with position information indicating a shooting position. Furthermore, the digital camera performs positioning at regular intervals even while shooting is not performed, and records log data which sequentially records position information obtained as a result of the positioning. Note that an apparatus to which the present invention is applicable is not limited to a digital camera, and an apparatus having a GPS reception function and a shooting function, such as a cellular phone, smart phone, notebook personal computer or PDA may be available. Assume that an application operating on a computer can receive image data and log data from a digital camera, and display, on a map, a moving route and a mark indicating a shooting position.

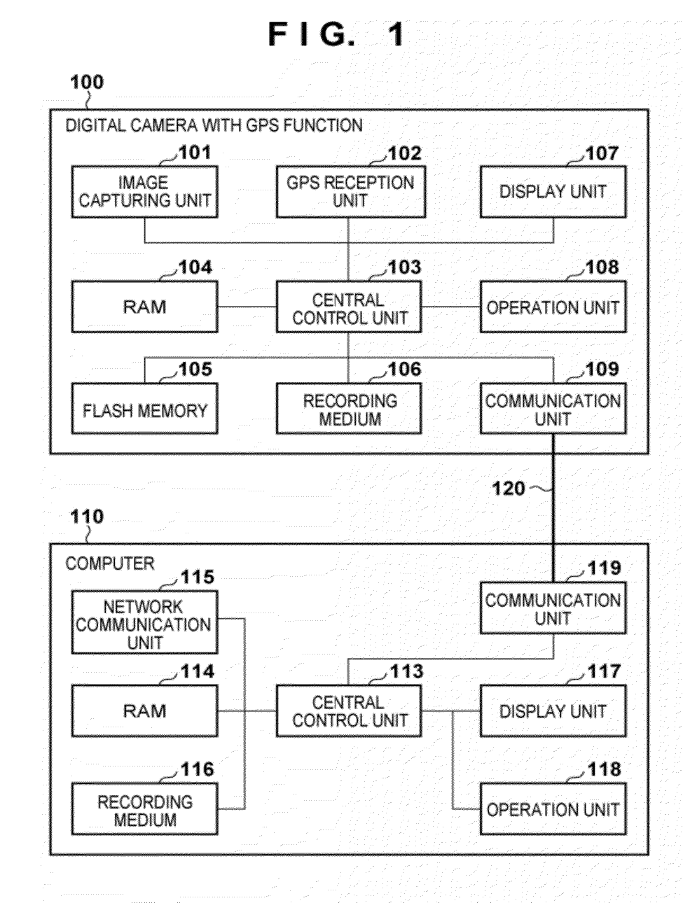

In this embodiment, as shown in FIG. 1, there exist a digital camera 100 with a GPS function and a computer 110. Connecting the apparatuses by a USB cable enables to make communication. The digital camera 100 can transfer image data and a GPS log file to the computer 110 via the USB cable.

Some functional blocks of the digital camera 100 and computer 110 shown in FIG. 1, which are not directly needed for understanding the configuration of the embodiment, are omitted. The digital camera 100 has an image capturing unit 101, a GPS reception unit 102, a central control unit 103, a RAM 104, a Flash Memory® 105, a recording medium 106, a display unit 107, an operation unit 108, and a communication unit 109.

The image capturing unit 101 includes a lens, shutter, aperture stop, and image sensor (CCD or CMOS), and images an appropriate amount of light from an object on the image sensor at an appropriate timing. The GPS reception unit 102 receives a signal from a GPS satellite, and calculates the current position of the self apparatus based on the received signal. UTC (Universal Time, Coordinated) which has been received together with the current position is provided to the central control unit 103. According to an input signal or program, the central control unit 103 executes various operations, and controls each component of the digital camera 100. More specifically, the central control unit 103 performs image capturing control, display control, recording control, communication control, and the like.

The RAM 104 is used as a temporary data storage area, and is used as a work area by the central control unit 103. The flash memory 105 records programs (firmware) for controlling the digital camera 100 and various kinds of setting information. The recording medium 106 records shot image data (including still image data and moving image data), and the like. Note that the recording medium 106 in this embodiment is assumed to be a so-called detachable storage medium. The storage medium is, for example, a memory card which can be mounted on a computer or the like to read out image data. Note that the storage medium can include any type of recording medium such as a hard disk, optical disk, magnetooptical disk, CD-R, DVD-R, magnetic tape, nonvolatile semiconductor memory, and flash memory. The digital camera 100 has a unit of accessing the recording medium 106 to read/write image data from/in the recording medium 106.

The display unit 107 displays a viewfinder image in shooting an image, a shot image, characters for interactive operations, and the like. Note that the digital camera 100 does not necessarily include the display unit 107, and need only have a display control function of controlling display of the display unit 107. In this case, it is possible to display a shot image and the like by connecting with an external display. The operation unit 108 serves as a user interface for accepting a user operation. For the operation unit 108, for example, buttons, a lever, a touch panel, and the like can be used. The communication unit 109 connects with an external apparatus to transmit/receive a control command and data. As a protocol for establishing a connection and communicating data, for example, PTP (Picture Transfer Protocol) is used. Note that a case in which the communication unit 109 makes communication via a wired connection using a USB (Universal Serial Bus) cable will be described in this embodiment. A communication method is not limited to this, and HDMI (High-Definition Multimedia Interface)® or the IEEE1394 method may be adopted. The communication unit 109 can include a wireless communication module such as an infrared communication module, a Bluetooth® communication module, wireless LAN communication module, and wireless USB. Furthermore, the communication unit may be directly connected with an external apparatus, or may be connected with an external apparatus via a network such as the Internet through a server.

One hardware component may control the digital camera 100, or a plurality of hardware components may function as units that share and execute processing in the digital camera 100. If the GPS reception unit 102 has received a signal from a GPS satellite, the central control unit 103 adds position information and UTC at the reception timing to shot image data. The image data is recorded as a file in an Exif format in the recording medium 106. Note that if the GPS reception unit 102 has not received a sufficient signal for calculation of position information, position information and UTC are not added to the image data.

The computer 110 serving as an information processing apparatus according to the embodiment of the present invention has a central control unit 113, a RAM 114, a network communication unit 115, a recording medium 116, a display unit 117, an operation unit 118, and a communication unit 119. The computer 110 incorporates an operating system (OS) in hardware, and has application software on it to execute various kinds of processes. According to an input signal or program, the central control unit 113 performs various operations, plays back data, and controls each component of the computer. The RAM 114 serves as a temporary data recording area, and is used as a work area by the central control unit 113.

The network communication unit 115 can transmit/receive data by connecting with an external server or the like via the Internet. The recording medium 116 is a hard disk drive (HDD) serving as an auxiliary storage unit, and stores various kinds of data and programs. The display unit 117 serves as a display in this embodiment, and displays an image or the screen of a program. The operation unit 118 is a keyboard, a mouse, or the like, and is used by the user to input to an application or the like. The communication unit 119 connects with an external apparatus to transmit/receive a control command and data. A USB interface is used to connect with the digital camera 100 in this embodiment. With respect to allowing other communication methods, the above description of the digital camera 100 is applicable.

Application software according to this embodiment will be described next. The central control unit 113 of the computer 110 loads programs contained in application software, and controls the respectively components of the computer 110, thereby implementing various kinds of processes.

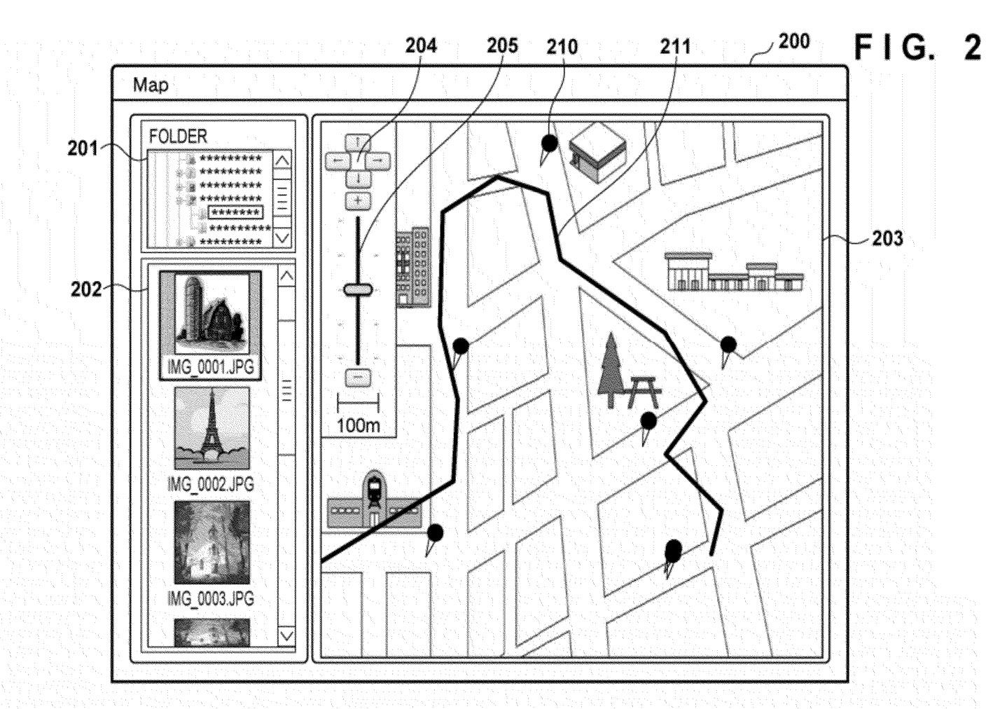

FIG. 2 shows the GUI of application software. Application software according to this embodiment can display a map on a screen. The application software refers to image data and a GPS log file transferred from the digital camera 100 to the recording medium 116 of the computer 110, and displays, on the map, a moving route and a mark indicating the presence of image data based on position information recorded in the files.

In a GUI 200 of the application shown in FIG. 2, a folder designation portion 201 is a region for selecting a folder containing image data to be processed in the application. In the folder designation portion 201, it is possible to select a folder formed within the recording medium 116 of the computer 110. The application software processes image data stored in the selected folder.

A thumbnail list display portion 202 displays a list of thumbnail images (reduced images) corresponding to the image data contained in the folder selected in the folder designation portion 201. A map display portion 203 is a display region for displaying map information in which the mark and moving route are superimposed. When the user operates map moving buttons 204 or a map scale change bar 205, the map display portion 203 can switch and display map information of an arbitrary position. Note that the application of this embodiment receives, via the network communication unit 115 from a server for providing a Web service, map data for generating a map, and displays the map. The present invention, however, is not limited to this. For example, the recording medium 116 may record map data in advance.

In this application, a mark 210 indicating the presence of image data is displayed according to position information contained in the image data corresponding to a thumbnail image displayed in the thumbnail list display portion 202. Furthermore, a moving route corresponding to a time-and-date when the image data is shot is displayed as a moving route 211.

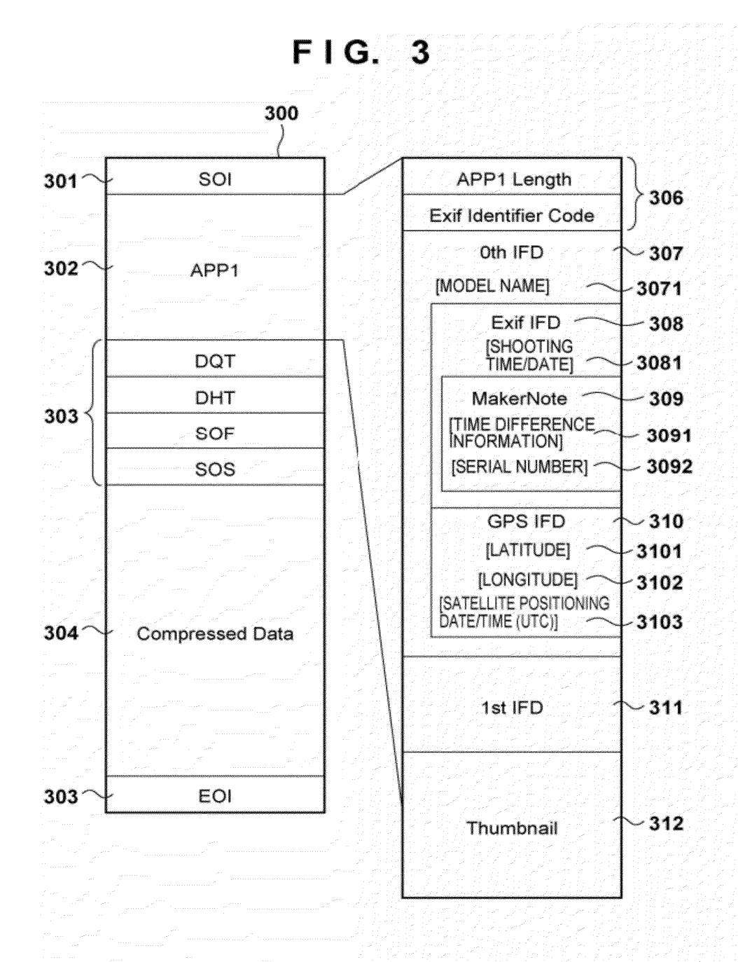

The data structure of image data according to the embodiment of the present invention for displaying such screen will be described with reference to FIG. 3. FIG. 3 shows an example of the data structure of image data 300 in this embodiment. The image data is generated by the digital camera 100, and is transferred to the computer 110. The computer 110 records the image data as a file in the recording medium 116. In this embodiment, an Exif-JPEG file format is used as the data structure of image data. A format having a data structure which can record metadata in image data such as an Exif-TIFF, RAW image, or moving image may also be used. Note that Exif (Exchangeable image file format) is the format of digital camera image metadata which has been decided by JEIDA (Japan Electronic Industry Development Association).

FIG. 3 shows the image data 300 as an example of the data structure of the Exif-JPEG 300. An SOI 301 serves as a marker indicating the start of the Exif-JPEG 300. An APP1 302 serves as an application marker corresponding to the header field of the Exif-JPEG 300. A data block 303 includes a quantization table (DQT), a Huffman table (DHT), a frame start marker (SOF), and a scan start marker (SOS). Compressed Data 304 is compressed data of a main image. An EOI 305 serves as a marker indicating the end of the Exif-JPEG 300.

The APP1 302 includes contents indicated by blocks 306 to 312. The data block 306 includes an APP1 Length indicating the size of the APP1 302 and an Exif Identifier Code indicating the identification code of the APP1 302. The 0th IFD 307 is a data block for recording attribute information about the compressed main image. The 0th IFD 307 includes, for example, a model name 3071 of the digital camera which has shot the image. In part of the 0th IFD 307, the data blocks of the Exif IFD 308 and the GPS IFD 310 exist. The Exif IFD 308 includes a tag associated with an Exif version, a tag associated with the characteristics and structure of the image data, a tag associated with a shooting time-and-date 3081, and a tag associated with shooting conditions such as a shutter speed and lens focal length.

In the Exif IFD 308, the data block of the MakerNote 309 exists. Information unique to a manufacturer which has generated the file is recorded in the MakerNote 309. The MakerNote 309 contains, for example, time difference information 3091 used in this embodiment, and a serial number 3092 indicating the unique number of the digital camera 100 used to shoot the image. The GPS IFD 310 includes a tag associated with GPS information. Position information such as a latitude 3101 and longitude 3102 used in this embodiment, and a satellite positioning time-and-date (UTC) 3103 are recorded in the GPS IFD 310. UTC (Coordinated Universal Time) indicates a standard time determined based on the International Atomic Time ticked by an atomic clock according to the international agreement. The 1st IFD 311 is a data block for recording attribute information associated with a thumbnail image. The Thumbnail 312 contains thumbnail image data.

The time difference information 3091 will now be described. The digital camera generally has a clock. When shooting an image, a time-and-date at that time is recorded as attribute information of the image in association with the image data 300. In this embodiment, the digital camera 100 has a clock, and the shot image data 300 contains the shooting time-and-date 3081 shown in FIG. 3. The digital camera 100 according to this embodiment can set the time difference between UTC and the time-and-date set in the clock of the camera. As the shooting time-and-date 3081, the generated image data 300 also records the time difference set in the camera, which corresponds to the time difference information 3091 of FIG. 3. If, for example, the user stays in Japan, the clock of the digital camera 100 is set to the Japan local time, and the time difference with respect to UTC is set to 9 hours (540 minutes). With this operation, a value of the shooting time-and-date according to the Japan local time is recorded as the shooting time-and-date 3081 of the shot image data 300, and a value of 9 hours (540 minutes) is recorded as the time difference information 3091. Note that a method of setting time difference information by the user in the digital camera 100 is not directly related to the present invention, and a description thereof will be omitted.

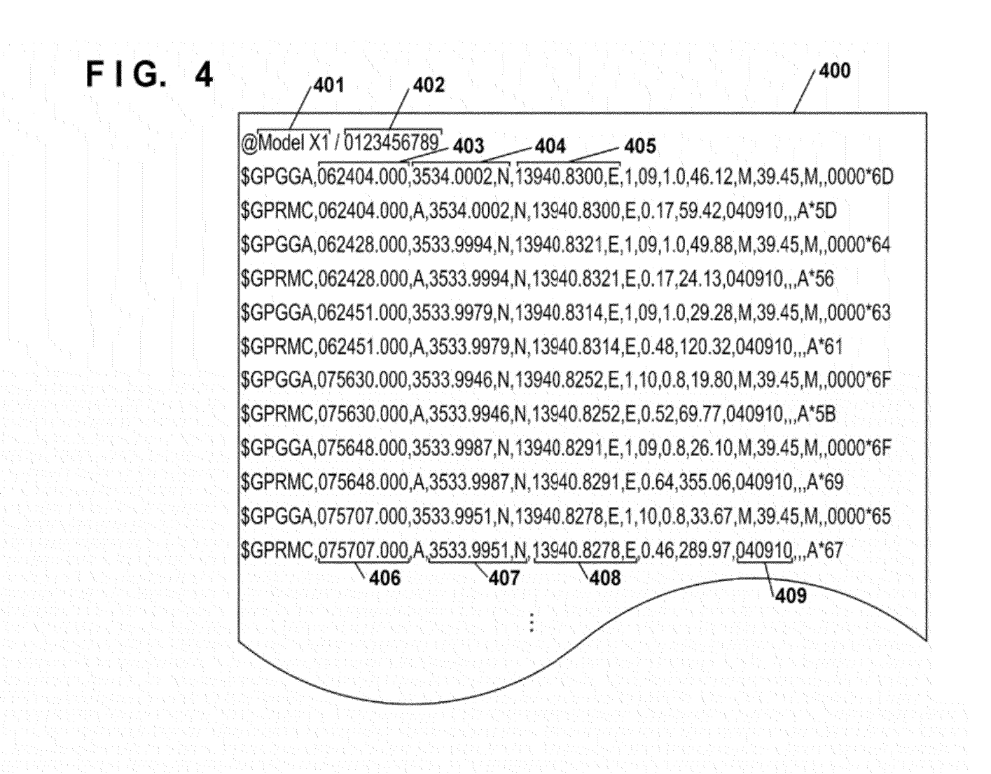

The structure of a GPS log file according to the embodiment will be described with reference to FIG. 4. FIG. 4 shows an example of the data structure of the GPS log file according to the embodiment. The central control unit 103 of the digital camera 100 with a GPS function saves the GPS log file in the recording medium 106 at regular intervals based on a signal which has been received in the GPS reception unit 102. Note that the digital camera 100 with a GPS function according to this embodiment prioritizes a shooting function as an actual function of a digital camera over a GPS log function. While, therefore, the digital camera 100 is in a shooting enable state, for example, while the digital camera is in a shooting mode or its power is on, the GPS log function does not operate.

At a first line, the model name and serial number of a GPS log apparatus are described. In this embodiment, since the digital camera has a function of the GPS log apparatus, a model name 401 and serial number 402 of the digital camera are described. At a second line and subsequent lines each starting with a mark “$”, messages complying with an NMEA-0183 format, which are output as log information by the GPS log apparatus by receiving signals, are described. The NMEA-0183 format is a standard, defined by NMEA (National Marine Electronics Association), for making communication using a serial port between a GPS receiver and a navigation device. In this embodiment, two types of messages, that is, GPGGA and GPRMC are recorded. The data fields of each message are separated by commas. GPGGA stands for Global Positioning System Fix Data. The following data fields are included in the order named:

a positioning time according to UTC (403),

a latitude and a symbol indicating a north latitude (N) or south latitude (S) (404),

a longitude and a symbol indicating an east longitude (E) or west longitude (W) (405),

the quality of the GPS,

the number of reception satellites,

HDOP (Horizontal Dilution of Precision),

an antenna altitude (m) above mean sea level,

the height (m) of mean sea level above the WGS-84 ellipsoid,

the age (sec) of DGPS data,

the ID of a DGPS reference station, and

a checksum.

GPRMC stands for Recommended Minimum Specific GNSS Data. The following data fields are included in the order named:

a positioning time according to UTC (406), a latitude and a symbol indicating a north latitude (N) or south latitude (S) (407),

a longitude and a symbol indicating an east longitude (E) or west longitude (W) (408),

a ground speed (knot),

the direction of travel (degree, true north),

a positioning date according to UTC (409),

a declination,

a mode, and

a checksum.

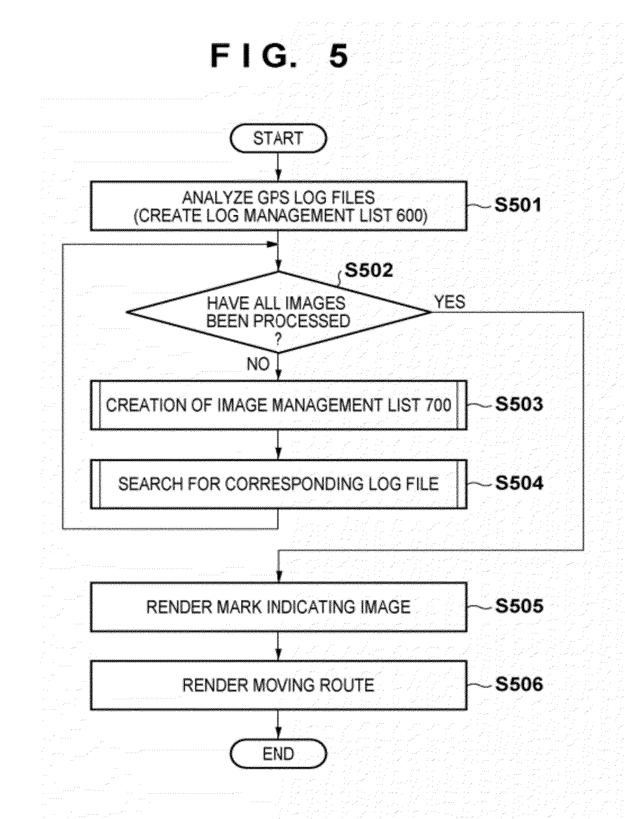

Processing for implementing the screen display function of FIG. 2 according to the embodiment of the present invention will be described with reference to FIGS. 5 to 9B. FIG. 5 is a flowchart illustrating processing when a folder is selected in the folder designation portion 201. Processing corresponding to FIG. 5 is implemented when, for example, the central control unit 113 executes a program recorded in the recording medium 116.

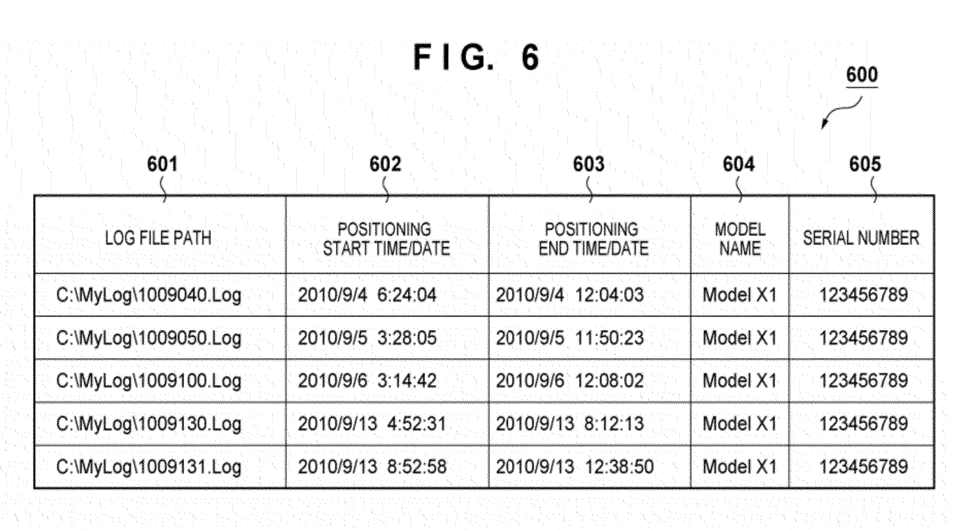

In step S501, the central control unit 113 analyzes GPS log files 400. The GPS log files 400 are saved in a predetermined folder within the recording medium 116. In step S501, the unit 113 sequentially refers to the GPS log files 400 recorded in the predetermined folder, and creates a log management list 600 shown in FIG. 6.

In the log management list 600 of FIG. 6, the file path of each GPS log file 400 is registered as a log file path 601. A time-and-date according to UTC when positioning starts, which has been extracted from the GPS log file 400 corresponding to the file path, is registered as a positioning start time-and-date 602. A time-and-date according to UTC when positioning ends, which has been extracted from the corresponding GPS log file 400, is registered as a positioning end time-and-date 603. The name of an apparatus which has created the log file is registered as a model name 604. The serial number of the apparatus which has created the log file is registered as a serial number 605. The serial number enables to uniquely identify the apparatus which has generated the log file.

Note that the log management list 600 shown in FIG. 6 is sorted in ascending order based on the positioning start time-and-date 602, and then managed. The log management list 600 may be recorded in the recording medium 116, or may be temporarily managed in the RAM 114. An example of a method of creating the log management list 600 will be described below. The GPS log files 400 contained in the predetermined folder are sequentially checked, and a path including the file name of the GPS log file is registered as the log file path 601. A value obtained based on the positioning times 403 and 406 and the positioning date 409 which are recorded in the first GPGGA/GPRMC of the message of the GPS log file 400 is registered as the positioning start time-and-date 602. A value obtained based on the positioning times 403 and 406 and the positioning date 409 which are recorded in the last GPGGA/GPRMC of the message of the GPS log file 400 is registered as the positioning end time-and-date 603. Furthermore, the model name 401 recorded in the header of the GPS log file 400 is registered as the model name 604. Similarly, the serial number 402 described in the header is registered as the serial number 605. This processing is executed for all the GPS log files 400.

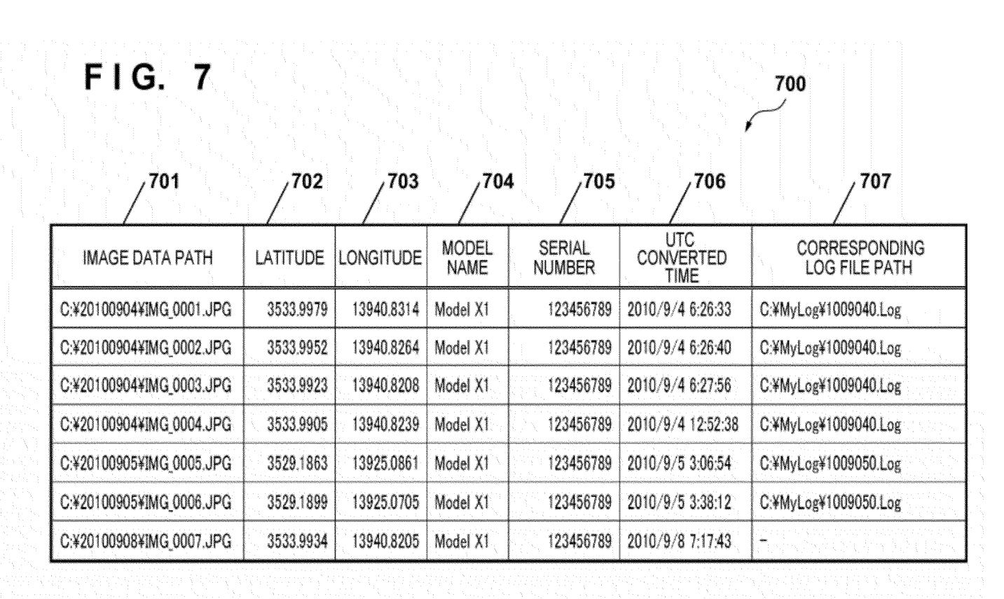

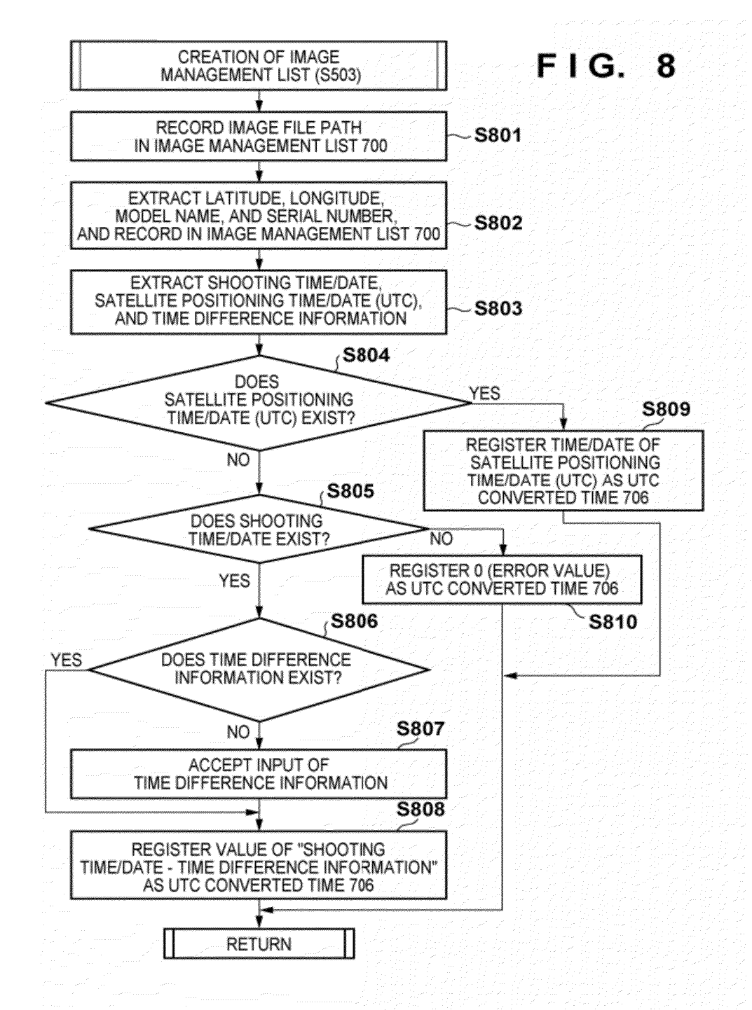

Referring back to FIG. 5, when the analysis processing in step S501 is completed, the central control unit 113 processes, one by one, the image data 300 contained in the folder designated in the folder designation portion 201, and creates an image management list 700 shown in FIG. 7. In step S502, the central control unit 113 determines whether all the target image data 300 have been processed. If there exists an unprocessed image (NO in step S502), the process advances to step S503; otherwise (YES in step S502), the process advances to step S505. In step S503, the central control unit 113 analyzes the image data 300 to be processed, and creates the image management list 700 which summarizes “image information” associated with the image data 300. When creating the image management list 700, processing of obtaining a UTC converted time (denoted by reference numeral 706 in FIG. 7) which serves as a key when a log file corresponding to the image data 300 is searched for is also executed. The processing in step S503 will be described in detail later with reference to FIGS. 7 and 8.

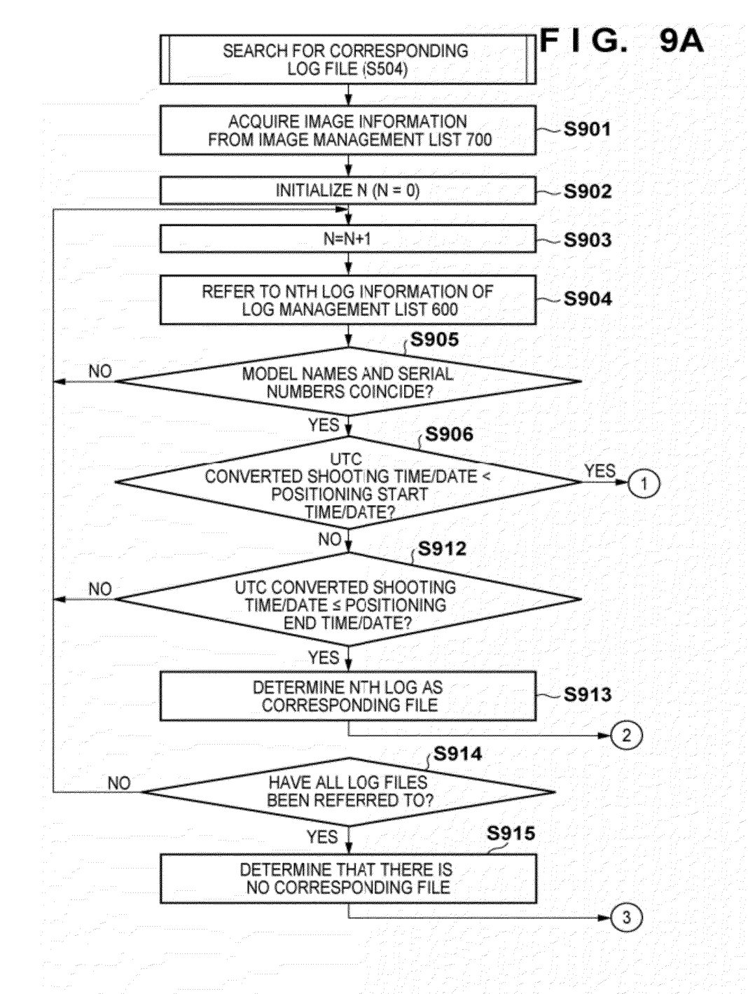

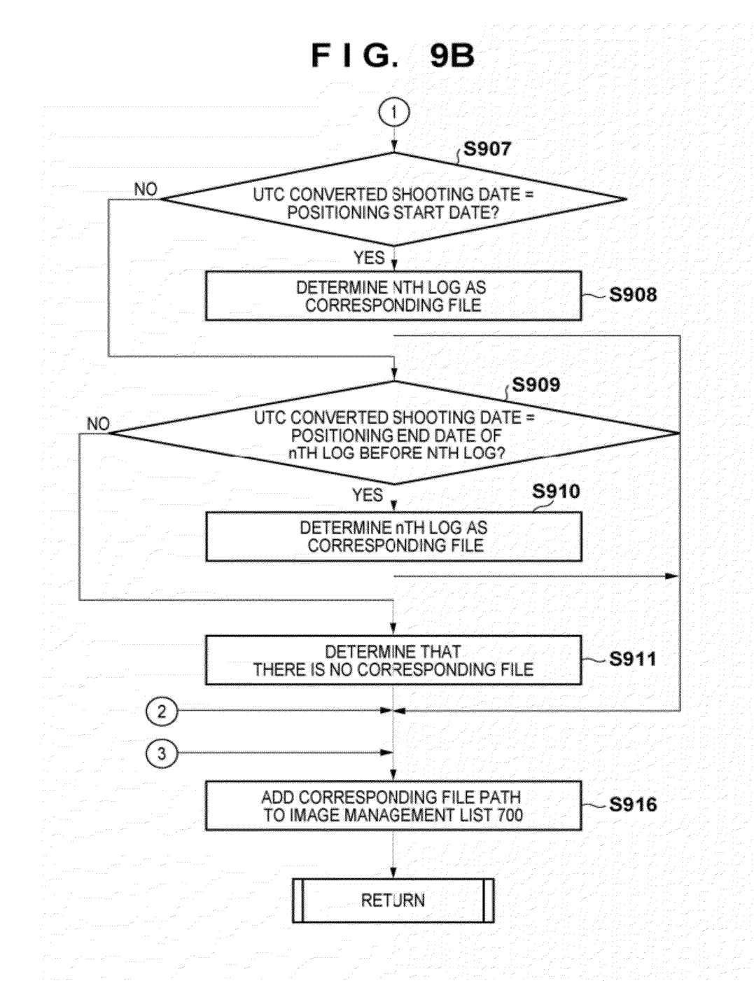

In step S504, the central control unit 113 searches for a corresponding log file based on the UTC converted time obtained in step S503, and returns the process to step S502. This processing will also be described in detail later with reference to FIGS. 9A and 9B. Note that the log file obtained here is used to render a moving route when the image data 300 being processed is shot. Information about the obtained log file is also recorded in the image management list 700.

In step S505, the central control unit 113 renders a mark indicating the presence of an image at a corresponding position in the map display portion 203 based on the image management list. In this embodiment, as shown in FIG. 2, the pin 210 is displayed, as the mark, on the map displayed in the map display portion 203. The pins 210 the number of which is equal to that of images that are managed by the image management list 700 and that record position information are rendered on the map.

In step S506, the central control unit 113 renders the moving route 211 on the map displayed in the map display portion 203. This processing is also executed based on the contents of the image management list. More specifically, the unit 113 refers to the image management list, and obtains, based on the log file path 601, the path of the log file found in step S504. Based on the obtained path, the corresponding log file is read out, and a point is set on the map based on position information of a latitude and longitude contained in each log file. The points are connected in the chronological order based on the positioning end time-and-date 603 contained in each log file, thereby forming the moving route 211 on the map.

The processing of creating the image management list in step S503 of FIG. 5 will be described in detail. An example of the data structure of the image management list is as shown in FIG. 7. The image management list 700 manages information obtained by analyzing all images contained in a folder designated by the user. A path indicating the storage location of the image data 300 is registered as an image data path 701. Position information about a location where the image data 300 is shot is registered as a latitude 702 and a longitude 703. The position information is acquired from information of the latitude 3101 and longitude 3102 contained in the GPS IFD 310 of the image data 300. The model name of the digital camera 100 serving as an image capturing apparatus which has generated the image data is acquired from information of the model name 3071 contained in the 0th IFD 307 of the image data 300, and is registered as a model name 704.

Identification information for uniquely identifying the digital camera is registered as a serial number 705. The serial number is acquired from the serial number 3092 of the MakerNote 309 of the image data 300. Information of the shooting time-and-date of the image data 300 is registered as the UTC converted time 706. A method of calculating the UTC converted time will be described in detail in processing in step S803 and subsequent steps of FIG. 8. The path of a log file corresponding to the image data 300 is registered as a corresponding log file path 707. The corresponding log file path 707 will be described in detail later.

The processing of creating the image management list 700 will be described with reference to FIG. 8. FIG. 8 is a flowchart illustrating an example of the processing of creating the image management list 700. In step S801, the central control unit 113 registers, as the image data path 701 of the image management list 700, a file path indicating the storage location of the image data 300 to be processed. It is possible to confirm the data path 701 based on the path of the folder designated in the folder designation portion 201 of FIG. 2, and the file name of the image. In step S802, the central control unit 113 analyzes the image data 300 acquired based on the image data path specified in step S801, and records a value in a predetermined item of the image management list 700. More specifically, the unit 113 extracts a latitude and longitude as position information of a location where the image is shot, and a model name and serial number for specifying a digital camera which has shot the image. These pieces of information can be extracted from the latitude 3101, longitude 3102, model name 3071, and serial number 3092 in the data structure of FIG. 3, and can be registered in the image management list 700.

In step S803, the central control unit 113 analyzes the image data 300, and acquires three values of the shooting time-and-date 3081, satellite positioning time-and-date (UTC) 3103, and time difference information 3091. These data are required for obtaining a “UTC converted time” as time information serving as a key when log data corresponding to the image data 300 is searched for. As described above with reference to FIG. 6, the GPS log file 400 is recorded in a predetermined folder, and the information is managed by the log management list 600. In the log management list 600, the positioning start time-and-date 602 and positioning end time-and-date 603 according to UTC are recorded as information of each GPS log file 400. To specify the GPS log file 400 corresponding to the image data, a time according to UTC when the image data 300 is shot is needed. To obtain this value, the above-mentioned three values are used.

Depending on image data, all the three data are not necessarily included. For example, even if the digital camera 100 of this embodiment shoots an image, an environment such as the interior of a room in which it is impossible to satisfactorily capture a radio wave from a GPS satellite is assumed. In such an environment, in addition to position information such as the latitude 3101 and longitude 3102, the satellite positioning time-and-date (UTC) 3103 is not recorded in the image data 300. Furthermore, the digital camera with no GPS function may shoot an image without setting time difference information. Since there is also a digital camera which does not incorporate a function of setting time difference information, time difference information is not necessarily acquired.

In step S804 and thereafter, the process branches depending on the type of acquired data. In step S804, the central control unit 113 determines whether the value of the satellite positioning time-and-date (UTC) 3103 has been acquired. If the value has been acquired (YES in step S804), the process advances to step S809. In this case, the UTC converted time is equal to the value of the satellite positioning time-and-date (UTC) 3103 extracted from the image data 300, and is recorded in the item of the UTC converted time 706 of the image management list 700. In this embodiment, information of the UTC converted time 706 obtained from the value of the satellite positioning time-and-date (UTC) 3103 will be referred to as “first time-and-date information”. On the other hand, if the value of the satellite positioning time-and-date 3103 does not exist (NO in step S804), the process advances to step S805. In step S805 and thereafter, if the first time-and-date information is not obtained, information of the UTC converted time 706 is generated by converting information of a shooting time-and-date described by a local time into a shooting time-and-date according to UTC. The generated information of the UTC converted time 706 will be referred to as “second time-and-date information” in this embodiment.

In step S805, the central control unit 113 determines whether the image data 300 has a value of the shooting time-and-date 3081. If the value exists (YES in step S805), the process advances to step S806; otherwise (NO in step S805), the process advances to step S810. In step S810, the central control unit 113 registers a value of 0 which indicates an error in the item of the UTC converted time 706 of the image management list 700. On the other hand, in step S806, the central control unit 113 also determines whether the image data 300 has a value of the time difference information 3091. If the value exists (YES in step S806), the process advances to step S808; otherwise (NO in step S806), the process advances to step S807.

In step S807, the user of the computer 110 is prompted, through the display unit 117, to input time difference information. In response to this, the user inputs time difference information using the keyboard and mouse of the operation unit 118. The definition of time difference information is as described above. If the digital camera is used in Japan, the time difference information indicates 9 hours (540 minutes). Upon accepting input of the time difference information in step S807, the process advances to step S808. In step S808, the central control unit 113 converts the value of the shooting time-and-date 3081 into UTC based on the time difference information held by the image data 300 or that input by the user. The central control unit 113 registers the obtained UTC converted time in the item of the UTC converted time 706 of the image management list 700, which serves as second time-and-date information.

As described above, it is possible to determine the value of the UTC converted time 706 for searching for the GPS log file 400 corresponding to the image data 300 regardless of the type of attribute information contained in the image data 300.

The processing of searching for a corresponding log file in step S504 of FIG. 5 will be described in detail with reference to the flowcharts shown in FIGS. 9A and 9B. In this embodiment, based on the value of the UTC converted time 706 determined when generating the image management list 700, the log management list 600 is referred to, and the GPS log file 400 corresponding to the image data 300 is searched for. The path of the found GPS log file 400 is registered as the corresponding log file path 707 of the image management list 700.

In step S901, the central control unit 113 acquires image information of the image data 300 from the image management list 700. In step S902, the central control unit 113 initializes a number N for selecting a log file registered in the log management list 600. The number N is used to select, in the registration order, log files registered in the log management list 600. The central control unit 113 increments the value of the number N in step S903, and refers to Nth log information of the log management list 600 in step S904. Whether an apparatus which has generated the image data 300 corresponding to the image information to be processed is an apparatus which has positioned the GPS log file 400 is determined in step S905 based on whether pieces of identification information of the apparatuses contained in both the data coincide with each other. More specifically, the central control unit 113 determines whether the contents of the model name and serial number of the image information acquired in step S901 coincide with those of the Nth log information referred to in step S904. If the model names or serial numbers do not coincide with each other (NO in step S905), the process returns to step S903. In this case, since the central control unit 113 can determine that an Nth GPS log file is not a corresponding one, it increments N in step S903 to select a next GPS log file. If the model names and the serial numbers coincide with each other (YES in step S905), the process advances to step S906 and the central control unit 113 compares a shooting time-and-date indicated by the UTC converted time 706 of the image information with a positioning start time-and-date 602 of the Nth GPS log file. If the shooting time-and-date indicated by the UTC converted time 706 is earlier than the positioning start time-and-date 602 of the Nth GPS log file (YES in step S906), the process advances to step S907; otherwise (NO in step S906), the process advances to step S912.

In step S907, the central control unit 113 compares the shooting date indicated by the UTC converted time 706 with the positioning start date of the Nth GPS log file, and then determines whether they coincide with each other, that is, whether the same date is indicated. If the dates coincide with each other (YES in step S907), the central control unit 113 determines the Nth GPS log file as a corresponding file in step S908, and advances the process to step S916. Alternatively, if the dates do not coincide with each other (NO in step S907), the central control unit 113 determines in step S909 whether the shooting date indicated by the UTC converted time 706 indicates the same date as the positioning end date of an nth log before the Nth log. Note that “nth log” indicates a GPS log file in which a model name and serial number coincide with those of the image information to be processed and the registration order is nearest to and earlier than that of the Nth GPS log file. If, for example, the model name and serial number of an (N−1)th GPS log file coincide with those of the image information to be processed, the (N−1)th GPS log file is a corresponding one.

More generally, with respect to the determinations in steps S906 and S907, it is determined in step S909 whether the shooting time-and-date indicates a time-and-date between two GPS log files 400 temporally adjacent to each other across days. In this determination processing, it is possible to specify a pair of GPS log files temporally adjacent to each other based on positioning time-and-date of each of the plurality of GPS log files 400. The term “temporally adjacent to each other” indicates the relationship between two GPS log files vertically adjacent to each other in the log management list 600 of FIG. 6 which has been sorted based on the positioning start time-and-date. Although it is possible to specify a plurality of pairs of log files, two GPS log files to be obtained will be referred to as a first GPS log file (the nth log) and a second GPS log file (the Nth log). The positioning time-and-date of the first GPS log file is earlier than that of the second GPS log file. The shooting time-and-date is earlier than the positioning start time-and-date of the second GPS log file. The shooting date indicates a date different from that indicated by the positioning start time-and-date of the second GPS log file while indicating the same date as that indicated by the positioning end time-and-date of the first GPS log file.

If it is determined in step S909 that the shooting date indicates the same date as the positioning end date of the nth log (YES in step S909), the process advances to step S910, and the central control unit 113 determines the nth GPS log file as a corresponding file. Then, the process advances to step S916. Alternatively, if the shooting date does not indicate the same date as the positioning end date of the nth log (NO in step S909), the process advances to step S911. In this case, the shooting date indicated by the UTC converted time 706 does not exist in any log, and therefore, the central control unit 113 determines in step S911 that there is no corresponding GPS log file.

In step S912, the central control unit 113 determines whether the shooting time-and-date indicated by the UTC converted time 706 is equal to or earlier than the positioning end time-and-date 603 of the Nth GPS log file. By considering the determination in step S912 in combination with the determination in step S906, it is determined whether the shooting time-and-date is between the positioning start time-and-date and the positioning end time-and-date.

If the shooting time-and-date is equal to or earlier than the positioning end time-and-date (YES in step S912), the process advances to step S913. In this case, since it can be determined that the shooting time-and-date is between the positioning start time-and-date and the positioning end time-and-date of the Nth GPS log file, the central control unit 113 determines the Nth GPS log file as a corresponding file in step S913, and advances the process to step S916. If the shooting time-and-date is not equal to or earlier than the positioning end time-and-date of the Nth GPS log file (NO in step S912), the process advances to step S914, and the central control unit 113 determines whether all the GPS log files have been referred to. If not all the GPS log files have been referred to (NO in step S914), the process returns to step S903 to continue; otherwise (YES in step S914), the central control unit 113 determines in step S915 that there is no corresponding GPS log file, and advances the process to step S916. In step S916, the central control unit 113 registers the path of the determined corresponding GPS log file as the corresponding log file path 707 of the image management list 700 of FIG. 7.

In the above description, the time axis of the shooting time-and-date of an image is converted into UTC in advance when creating the image management list 700, and a corresponding GPS log file is determined. The present invention, however, is not limited to this. The time axis of time information associated with the positioning time-and-date of a GPS log file may be converted into a local time by adding a time difference with respect to UTC, thereby determining a corresponding GPS log file.

In the determination processes in steps S907 and S909 of FIG. 9B, a GPS log file in which a positioning start date or positioning end date indicates the same date as the shooting date of an image is determined as a corresponding file. There is no GPS log file, in the image management list 700, in which the same date as that indicated by the UTC converted time is indicated, and therefore, it is recorded that there is no corresponding GPS log file path for an image data path “C:¥20100908¥IMG_{—}0007.JPG”. Even if, however, there is no GPS log file in which the same date is indicated, a GPS log file in which a positioning start time-and-date or positioning end time-and-date is nearest to the UTC converted time may be determined as a corresponding file. Note that a GPS log file in which a positioning start time-and-date or positioning end time-and-date is nearest to the UTC converted time may not be determined as a corresponding file when a difference with respect to a nearest date exceeds a predetermined number of days.

Although the embodiment of the present invention has been explained, the present invention is not limited to this, and various modifications and changes can be made within the spirit and scope of the present invention. For example, processing of creating an image management list may be executed when transferring data from another device to the computer 110.

Assume that both image data and GPS log data are recorded in the storage unit of a given device. In this case, even if a model name or serial number is not added to those data, it is estimated that the same device has probably generated those data. If a transfer operation of the image data and GPS log data from the device to the computer is executed as a series of processes, the computer generates an image management list 700 by executing the process shown in FIG. 8 in the transfer operation. Since it is impossible to set the model name 704 or serial number 705 of the image management list 700 as a matter of course, a unique value such as a UUID automatically generated at that time is set instead. The generated image management list 700 is saved as a file in the recording medium 116.

Similarly, for the transferred GPS log file, the processing in step S501 of FIG. 5 is executed to create a log management list 600. In this case, since it is impossible to extract a model name or serial number from the GPS log file, an automatically generated UUID or the like is set, as described above. This makes it possible to perform association even if each of the image data and GPS log file does not contain a common model name or serial number. When a map is displayed by an application, it is possible to perform appropriate display by associating each point on the map with image data.

Note that it is possible to obtain the same effects by embedding a unique ID as the serial number of the transferred image data or GPS log file instead of automatically setting a unique ID in creating the image management list 700 or log management list 600.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-023243, filed Feb. 4, 2011 which is hereby incorporated by reference herein in its entirety.

What is claimed is:

1. An information processing apparatus comprising:
an acquisition unit configured to acquire, from each of a plurality of image data, information of a time-and-date when the image data is shot, and to acquire information of a positioning time-and-date from each of a plurality of GPS log files; and
a processing unit configured to specify a GPS log file corresponding to each image data by comparing the information of a time-and-date when the image data is shot acquired from each of the plurality of image data with the positioning time-and-date information acquired from each of the plurality of GPS log files,
wherein in a case that the information of the time-and-date when the image data is shot contains first time-and-date information according to UTC (Universal Time, Coordinated), said processing unit specifies the corresponding GPS log file by comparing the first time-and-date information with the positioning time-and-date information, and
in a case that the information of the time-and-date when the image data is shot contains not the first time-and-date information but information of a shooting time-and-date described by a local time, said processing unit converts the shooting time-and-date information into second time-and-date information according to UTC based on time difference information, and specifies the corresponding GPS log file by comparing the second time-and-date information with the positioning time-and-date information.

2. The apparatus according to claim 1, further comprising,
an operation unit configured to accept input from a user of said apparatus,
wherein in a case that the information of the time-and-date when the image data is shot contains the time difference information, said processing unit performs conversion into the second time-and-date information using the time difference information, and
in a case that the information of the time-and-date when the image data is shot does not contain the time difference information, said processing unit performs conversion into the second time-and-date information using time difference information input through said operation unit.

3. The apparatus according to claim 1, wherein
the positioning time-and-date information contains information of a positioning start time-and-date and a positioning end time-and-date, and
in a case that there is a GPS log file, of the plurality of GPS log files, in which a time-and-date indicated by the first time-and-date information or the second time-and-date information is between the positioning start time-and-date and the positioning end time-and-date, said processing unit specifies the GPS log file as the corresponding GPS log file.

4. The apparatus according to claim 3, wherein in a case that there is a GPS log file, of the plurality of GPS log files, in which the time-and-date indicated by the first time-and-date information or the second time-and-date information is earlier than the positioning start time-and-date and indicates the same date as that indicated by the positioning start time-and-date, said processing unit specifies the GPS log file as the corresponding GPS log file.

5. The apparatus according to claim 4, wherein for a pair of a first GPS log file and second GPS log file, of the plurality of GPS log files, which are adjacent to each other with respect to the positioning time-and-date and in which a positioning time-and-date of the first GPS log file is earlier than that of the second GPS log file, in a case that the time-and-date indicated by the first time-and-date information or the second time-and-date information is earlier than the positioning start time-and-date of the second GPS log file, and indicates a date different from that indicated by a positioning start time-and-date of the second GPS log file but indicates the same date as that indicated by a positioning end time-and-date of the first GPS log file, said processing unit specifies the first GPS log file as the corresponding GPS log file.

6. The apparatus according to claim 1, wherein said processing unit specifies the corresponding GPS log file from GPS log files, of the plurality of GPS log files, each of which has the same identification information as that contained in the image data for identifying an apparatus that has generated the image data.

7. The apparatus according to claim 1, wherein said processing unit does not specify the corresponding GPS log file in a case that the image data does not contain the information of the time-and-date when the image data is shot.

8. A control method for an information processing apparatus, comprising:
acquiring, from each of a plurality of image data, information of a time-and-date when the image data is shot, and acquiring information of a positioning time-and-date from each of a plurality of GPS log files; and
specifying a GPS log file corresponding to each image data by comparing the information of a time-and-date when the image data is shot acquired from each of the plurality of image data with the positioning time-and-date information acquired from each of the plurality of GPS log files,
wherein in a case that the information of the time-and-date when the image data is shot contains first time-and-date information according to UTC (Universal Time, Coordinated), the corresponding GPS log file is specified by comparing the first time-and-date information with the positioning time-and-date information, and
in a case that the information of the time-and-date when the image data is shot contains not the first time-and-date information but information of a shooting time-and-date described by a local time, the shooting time-and-date information is converted into second time-and-date information according to UTC based on time difference information, and the corresponding GPS log file is specified by comparing the second time-and-date information with the positioning time-and-date information.

9. A non-transitory computer readable storage medium storing a computer program which causes a computer to function as an information processing apparatus comprising:
an acquisition unit configured to acquire, from each of a plurality of image data, information of a time-and-date when the image data is shot, and to acquire information of a positioning time-and-date from each of a plurality of GPS log files; and
a processing unit configured to specify a GPS log file corresponding to each image data by comparing the information of a time-and-date when the image data is shot acquired from each of the plurality of image data with the positioning time-and-date information acquired from each of the plurality of GPS log files,
wherein in a case that the information of the time-and-date when the image data is shot contains first time-and-date information according to UTC (Universal Time, Coordinated), the processing unit specifies the corresponding GPS log file by comparing the first time-and-date information with the positioning time-and-date information, and in a case that the information of the time-and-date when the image data is shot contains not the first time-and-date information but information of a shooting time-and-date described by a local time, the processing unit converts the shooting time-and-date information into second time-and-date information according to UTC based on time difference information, and specifies the corresponding GPS log file by comparing the second time-and-date information with the positioning time-and-date information.
